(19) United States
(12) Patent Application Publication
(10) Pub. No.: US 2001/0039003 A1
(43) Pub. Date: Nov. 8, 2001

(54) Multi-lingual global distance learning system with database manager for automatic progressive learning

(76) Inventor: Bin Huang, Fremont, CA (US)

Correspondence Address: Bo-In Lin, 13445 Mandoli Drive, Los Altos Hills, CA, 94022, US

(21) Appl. No.: 09/844,542

(22) Filed: Apr. 27, 2001

Related U.S. Application Data
(60) Provisional application No. 60/200,544, filed on Apr. 27, 2000.

(51) Int. Cl. G09B 3/00

(52) U.S. Cl. 434/350

(57) ABSTRACT

The present invention discloses a method for providing a network global self-learning-and-testing center. The global self-learning and testing center includes a database for storing a plurality of self-tests provided for carrying out an on-line self-test by a network learner. The global self-learning and testing center further includes a language translation processing means provided to the network learner to select a self-learning-language and for translating the on-line self-test into the self-learning language. The global self-learning and testing center further includes a self-learning and-testing processing means for interacting with the network self-learner for carrying out the on-line self-test and for grading the on-line self-test. In a preferred embodiment, the global self-learning and testing center further includes a self-learner evaluation means for evaluating and determining a level of the elf-learner for providing a level-matched self-test to carry out the on-line self-test. In another preferred embodiment, the self-learner evaluation means further includes a level progress and certificate means for controlling a level progress of a network self-learner and for providing a level certification to the network self-learner according to grades received by the network self-learner after taking multiple on-line self tests.

This Application claims a priority date of Apr. 27, 2000 benefited from a previously filed Provisional Patent Application 60/200,544 filed on Apr. 27, 2000 by the Applicant of this Formal Patent Application.

### BACKGROUND OF THE INVENTION

1. Field of the Invention

This invention relates generally to a computer network system and data communication for carrying out a distance-learning process. More particularly, this invention relates to a global distance learning system involving multiple languages, database management for automatic test grading, advancement qualification, and progressive learning aided by and taking advantage of low-cost global data communication Internet network.

2. Description of the Prior Art

Current technology for networked “information-highway”, e.g., the Internet system, when applied for distance learning is still limited to formal institutional type of models. More specifically, the techniques are employed mostly with educational presentations or tests sponsored by educational institutions. The applications are oriented to the purposes of allowing a teacher to interact with the students and for carrying out a test and then grading test such that the students can receive school credits according to test results. Furthermore, the educational materials and tests are presented in one particular language when placed on the network. A foreign student, without sufficient knowledge of particular language would not be able to receive the benefits of either viewing the education materials or taking self initiative to carry out self-evaluation tests to effect a progressive learning process. Furthermore, what is lacking are also system and method for enabling and allowing global distance learning with database and management systems to effect a “self-learning through self-testing, self-evaluation and progressive learning. The distance learning should also be provided to any person that has access to the Internet without being limited by the languages, geographic location, or being required to associate with a formal educational institute.

Walker et al. disclose in U.S. Pat. No. 5,947,747, entitled “Method and Apparatus for Computer-Based Educational Testing” (issued on Sep. 7, 1999), methods and apparatuses for computer based evaluation of a test-taker's performance with respect to selected comparative norms. As that shown in FIG. 1, Walker's system includes a home-testing computer for transmitting the test-taker's test results to a central computer, which derives a performance assessment of the test taker. The performance assessment can be standardized or customized, as well as relative or absolute. The transmitted test results are configured to reliably associate the student with his test results, using encoding, user identification, or corroborative techniques to deter fraud. The patented invention is limited to formal types of educational tests for the purpose of receiving school credits. Furthermore, the methods and apparatuses do not resolve the difficulties that a foreign person without sufficient knowledge of the English language or particular language is enabled to receive the benefits from such systems.

Therefore, a need still exists in the art of network data communication to provide a global multi-lingual system for distance learning that is further provided with database management system to provide flexibility of self-evaluation test and automatic progressive learning. Features such as automatic test monitoring and grading, grade-advancement qualifications, and automatic selection of teaching and testing materials from database are also required such that automatic networked global progressive learning can be achieved.

### SUMMARY OF THE PRESENT INVENTION

It is therefore an object of the present invention to provide a system and method to enable a network self-learner to carry out global self-learning and testing processes. Such global learning and testing processes are available without being required to participate a formal educational institute and without being limited to employ a particular language such that global self-learn and testing can be more flexibly available. The new and improved system and methods thus enable those of ordinary skill in the art to overcome the aforementioned difficulties and limitations encountered in the prior art.

Specifically, it is an object of the present invention to provide a global self-learning and testing center for providing a network self-learner to select a self-learner language and to retrieve concept-guidance and corrective feedback curriculums with associate self tests to carry out the self learning processes. The global self-testing and learning center further provides self-test grading/correction/analysis to provide corrective feedback to a network self-learner such that critical concept of each curriculum can be progressively learned by the network self-learner.

Another object of the present invention is to provide a system and method to store a profile of a network self-learner for providing level-appropriated self-testing and leaning curriculum for each network self-learner.

Another object of the present invention is to provide a method and system for carrying out a distributed real-time online competitive test by simultaneously providing a competitive test to a plurality of network competitors. The test grading/correction/analysis report for each of the competitors may be available to provide corrective-feedback to enhance the learning experience of each participant of the online academic competitive tests.

Briefly, in a preferred embodiment, the present invention discloses a network global self-learning-and-testing center. The global self-learning and testing center includes a database for storing a plurality of self-tests provided for carrying out an on-line self-test by a network learner. The global self-learning and testing center further includes a language translation processing means provided to the network learner to select a self-learning-language and for translating the on-line self-test into the self-learning language. The global self-learning and testing center further includes a self-learning and-testing processing means for interacting with the network self-learner for carrying out the on-line self-test and for grading the on-line self-test. In a preferred embodiment, the global self-learning and testing center further includes a self-learner evaluation means for evaluating and determining a level of the self-learner for providing a level-matched self-test to carry out the on-line self-test. In another preferred embodiment, the self-learner evaluation means further includes a level progress and certificate means for controlling a level progress of a network self-learner and for providing a level certification to the network self-learner according to grades received by the network self-learner after taking multiple on-line self tests.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a functional block diagram for illustrating a conventional configuration of a computer-based educational testing system disclosed in a prior art patent;

FIGS. 2 and 3 are functional block diagrams for illustrating a new configuration of a global self-learning and testing center of this invention.

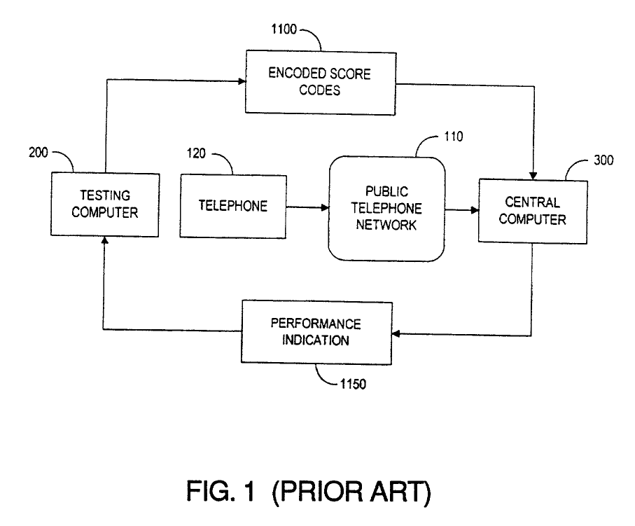

### DETAILED DESCRIPTION OF THE PREFERRED EMBODIMENT

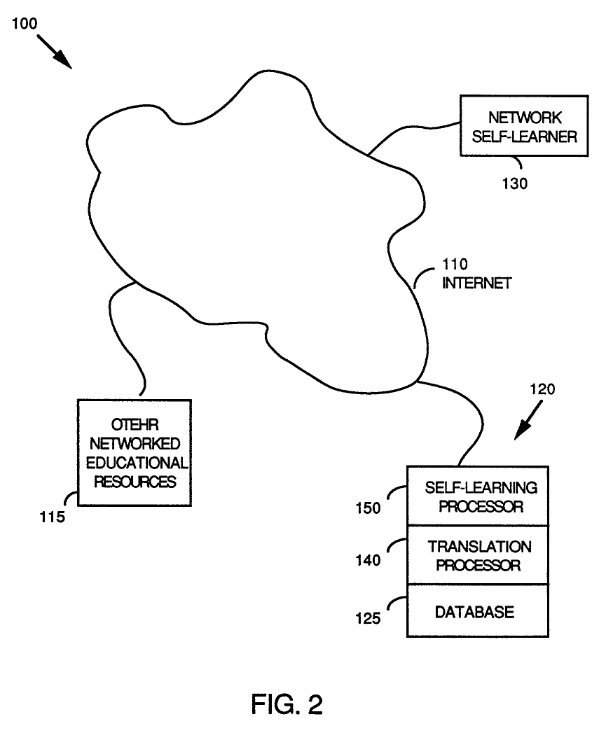

Referring to FIG. 2 for a functional block diagram for depicting an architecture overview of a progressive self-learning network of the present invention. The self-learning network 100 provides an improved system for a self-learner 130 to carry out a progressive self-learning process by connecting to a global learning center 120 through a network system, e.g., an Internet system 110. Other network educational resources 115 are also available on the Internet system 110. The global learning center 120 has a database 125 for storing a plurality of self-tests that could be made available to the network self-learner 130 for carrying out online self-tests. The global learning centerl20 further includes a translation processing means 140 provided to the network self-learner to select a self-learning language for translating an online self test into the language selected by the network self learner 130. The global self-learning center 120 further includes a self-learning processor 150 to process different self-learning processes includes interactions with the network self-learner to carry out a self-test translated into a self-learning language by the translation processor 140.

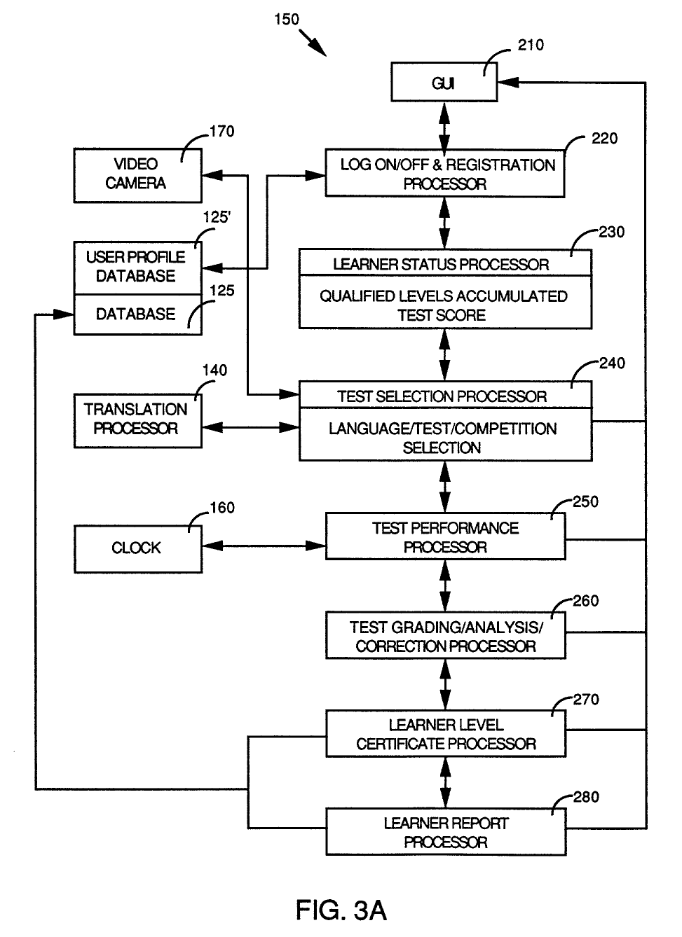

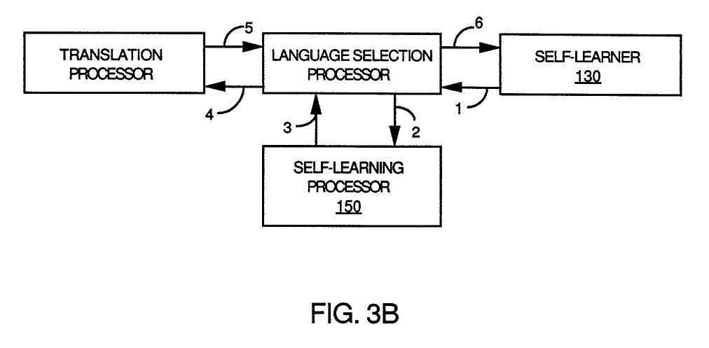

Referring to FIGS. 3A and 3B for a more detail configuration of the self-learning processor 150, which interfaces with the database 125, the translation engine 140 and a clock 160 to carry out different self-learning processes. The self-learning processor 150 includes a graphic user interface (GUI) that may be an Internet web browser 210 to interface with the network self-learner 130. A network self-learner 130 first carries out a registration or a log-on/log-off process through a registration-log-on/off processor 220 to enter into an interactive session with the global self-learning center 120. A self-learner profile 125′ of the database 125 provides data to the registration-log-on/off processor 220 to complete the registration or log-on/off processes. The learner status processor 230 is invoked to retrieve the qualified level and the accumulated scores of the network self-learner 130 for providing level-appropriated self-tests or competition-tests. Depending on the test/competition and language selected by the network self-learner 130, the test/competition/language selection processor 240 retrieves from the database 125 selected self-test or competition test. The translation engine 140 is also invoked to translate the selected test into the leaner selected language. The test performance processor 250 aided by the clock 160 then carries out an online test for the network self-learner 130. After the self-learning test or competition test is completed, a test grading/correction/analysis processor 260 is invoked to grade the test, provide the correct answer and carries out a test-result analysis of the self-learning test taken by the network self-learner 130. When the network self-learner 130 complete the requirements set for a particular self-learning level, a level certificate processor 270 is invoked to provide a certificate to the network self-learner 130. The self-learning processor 150 further includes a learner report processor 280 to present a self-learner report about the test scores and self-learning level or a competition ranking achieved by the network self-learner 130. For carrying out a competition, a video camera 170 may be provided for the self-learning processor 150 to monitor the activities of the network self-learner 130 over an entire process of taking the competition-test. The purpose is to assure a fair competition is carried out among many competitors participate in the online real-time academic competition.

For the purpose of providing progressive self-learning system for the global self-learning center 120, the self-learning processor 150 implements a concept-guidance and corrective feedback processor 260-G. The concept-guidance and corrective-feedback processor 260-G is implemented as part of the test grading/correction/analysis processor 260. The concept-guidance and corrective-feedback processor 260-G divides the self-learning process into concept-guidance curriculums wherein each curriculum includes a section of concept definition, followed by concept example presentation for interactively presenting the concept definition and the examples to the network self-learner 130. The concept-guidance and corrective-feedback processor 260-G then link each concept curriculum to several sets of self-tests for testing each critical concept with such sets of self-test questions retrieved from the database 125. The test grading/correction/analysis processor 260 provides a concept analysis to provide the network self-learner 130 corrective feedback for each test question that is not correctly answered. The results of the self-test is further evaluated by the grading/correction/analysis processor 260 to determine that for each major concept in one self-learning level, the network self-learner 130 has achieved sufficient points to advance to a next higher level of self-learning. Then the self-learning level certificate processor 270 generates a level certificate to allow the network self-learner to start a self-learning processor of the major concepts presented in the next level.

According to FIGS. 2 and 3, a network global self-learning-and-testing center 120 is disclosed in this invention. The global self-learning and testing center 120 includes a database 125 for storing a plurality of self-tests provided for carrying out an on-line self-test by a network learner 130. The global self-learning and testing center 120 further includes a language translation processing means 140 provided to the network learner to select a self-learning-language and for translating the on-line self-test into the self-learning language. The global self-learning and testing center 120 further includes self-learning and-testing processing means 150 for interacting with the network self-learner for carrying out the on-line self-test and for grading the on-line self-test. In a preferred embodiment, the global self-learning and testing center 120 further includes a self-learner evaluation means 260 for evaluating and determining a level of the self-learner for providing a level-matched self-test to carry out the on-line self-test. In a preferred embodiment, the self-learner evaluation means 260 further comprising a level progress and certificate means 270 for controlling a level progress of a network self-learner 130. The self-learner evaluation means 270 is also implemented for providing a level certification to the network self-learner 130 according to grades received by the network self-learner after taking multiple on-line self-tests. In a preferred embodiment, the self-learner evaluation means 260 further comprising a test answer analysis means 260-G for analyzing answers received from a network self-learner and for providing a set of corrective exercise tests for assisting a learning process of the network self-learner. In a preferred embodiment, the global self-learning center further includes a competition means for simultaneously interacting with a plurality of network self-learners 130 for carrying out an on-line competitive test. In a preferred embodiment, the global self-learning center further includes a timer 160 for carrying out the on-line self-test in a fixed length of time. In a preferred embodiment, the test answer analysis means 260-G further comprising a formulation analysis means for analyzing formulations in the answers received from a network self-learner. In a preferred embodiment, the test answer analysis means 260-G further comprising a unit conversion analysis means for analyzing a unit conversion in the answers received from a network self-learner. In a preferred embodiment, the test answer analysis means 260-G further comprising a concept analysis means for analyzing concepts in the answers received from a network self-learner. In a preferred embodiment, the global self-testing and learning center 120 further includes a network self-learner registration means 220 for registering a network self-learner 130 and for logging on and maintaining a record of the network self-learner. In a preferred embodiment, the global self-testing and learning center 120 further includes a video monitoring means 170 for monitoring activities of a network self-learner in carrying out the on-line competition. In a preferred embodiment, the global self-testing and learning center 120 further includes an Internet Web server 210 for interacting with the network self-learner 130 for carrying out the on-line self-test.

Therefore, the present invention provides a system and method to enable a network self-learner to carry out global self-learning and testing processes. Such global learning and testing processes are available without being required to participate a formal educational institute and without being limited to employ a particular language such that global self-learn and testing can be more flexibly available. The new and improved system and methods thus enable those of ordinary skill in the art to overcome the difficulties and limitations encountered in the prior art. Specifically, a network self-learner is enabled to select a self-learner language and to retrieve concept-guidance and corrective feedback curriculums with associated self-tests in user selected language to carry out the self-learning processes. The global self-testing and learning center further provides self-test grading/correction/analysis to provide corrective feedback to a network self-learner such that critical concept of each curriculum can be progressively learned by the network self-learner. A profile of a network self-learner is stored for providing level-appropriated self-testing and leaning curriculum. This invention also discloses a method and system for carrying out a distributed real-time online competitive test by simultaneously. A competitive test is made available online to a plurality of network competitors. Meanwhile, the test grading/correction/analysis report for each of the competitors may also be made available to provide corrective-feedback to enhance the learning experience of each participant of the online academic competitive tests.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A network global self-learning-and-testing center comprising:
a database for storing a plurality of self-tests provided for carrying out an on-line self-test by a network learner;
a language translation processing means provided to said network learner to select a self-learning-language and for translating said on-line self-test into said self-learning language; and
a self-learning and-testing processing means for interacting with said network self-learner for carrying out said on-line self test and for grading said on-line self-test.

2. The network global self-learning-and-testing center of claim 1 further comprising:
a self-learner evaluation means for evaluating and determining a level of said self-learner for providing a level-matched self-test to carry out said on-line self-test.

3. The network global self-learning-and-testing center of claim 1 wherein:
said self-learner evaluation means further comprising a level progress and certificate means for controlling a level progress of a network self-learner and for providing a level certification to said network self-learner according to grades received by said network self-learner after taking multiple on-line self tests.

4. The network global self-learning-and-testing center of claim 1 wherein:
said self-learner evaluation means further comprising a test answer analysis means for analyzing answers received from a network self-learner and for providing a set of corrective exercise tests for assisting a learning process of said network self-learner.

5. The network global self-learning-and-testing center of claim 1 further comprising:
a competition means for simultaneously interacting with a plurality of network self-learners for carrying out an on-line competitive test.

6. The network global self-learning-and-testing center of claim 1 further comprising:
a timer for carrying out said on-line self-test in a fixed length of time.

7. The network global self-learning-and-testing center of claim 6 further comprising:
a timer for carrying out said on-line competitive test in a fixed length of time.

8. The network global self-learning-and-testing center of claim 4 wherein:
said test answer analysis means further comprising a formulation analysis means for analyzing formulations in said answers received from a network self-learner.

9. The network global self-learning-and-testing center of claim 4 wherein:
said test answer analysis means further comprising a unit conversion analysis means for analyzing a unit conversion in said answers received from a network self-learner.

10. The network global self-learning-and-testing center of claim 4 wherein:
said test answer analysis means further comprising a concept analysis means for analyzing concepts in said answers received from a network self-learner.

11. The network global self-learning-and-testing center of claim 1 further comprising:
a network self-learner registration means for registering a network self-learner and for logging on and maintaining a record of said network self-learner.

12. The network global self-learning-and-testing center of claim 1 further comprising:
a video monitoring means for monitoring activities of a network self-learner in carrying out said on-line self-test.

13. The network global self-learning-and-testing center of claim 5 further comprising:
a video monitoring means for monitoring activities of said network self-learners in carrying out said on-line competitive test.

14. The network global self-learning-and-testing center of claim 1 further comprising:
an Internet Web server for interacting with said network self-learner for carrying out said on-line self-test.

15. A method for providing a self-learning-and-testing process comprising:
a) providing an Internet log-on and language selection means for allowing an Internet self-learner to log-on to a global self-learning-and testing center and for selecting a self-learning language;
b) providing a on-line test selection means for allowing said Internet self-learner to select an on-line self-test from a self-test database containing a plurality of self-tests in different languages;
c) providing an automatic translation processor on said self-learning-and-testing center to translate said on-line self-test into said self-learning language;
d) interacting and guiding said Internet self-learner to complete said on-line self-test; and
e) providing a grade to said Internet self-learner after completion of said on-line self-test and issues a passing certificate for allowing said Internet self-learner to select a next-level on-line self-test when said grade satisfies a passing grade.

16. The method of claim 15 wherein:
said step e) of interacting with and guiding said Internet self-learner to complete said on-line self-test further comprising a step of e1) of providing a monitoring video camera for monitoring said Internet self-learner in completing said self-test.

17. The method of claim 15 wherein:
said step c) of allowing said Internet self-learner to select an on-line self-test from a self-test database further comprising a step c1) of requesting a level certificate for allowing said Internet self-learner to select a self-test at a level corresponding to said level certificate.

18. The method of claim 15 wherein:
said step c) of allowing said Internet self-learner to select an on-line self-test from a self-test database further comprising a step c2) of allowing said Internet self-learner to select a self-test provided by a selected institute at a selected date from said self-test database.

19. The method of claim 15 wherein:
said step c) of providing an on-line test selection means for allowing said Internet self-learner to select an on-line self-test further comprising a step c3) of linking to a different Web site for retrieving said on-line self-test selected by said Internet self-learner.

20. The method of claim 19 wherein: said step c3) of linking to said different Web site for retrieving said on-line self-test selected by said Internet self-learner further comprising a step c4) of retrieving and storing said on-line self-test into said self-test database.
